(19) United States
(12) Patent Application Publication
(10) Pub. No.: US 2013/0305248 A1
(43) Pub. Date: Nov. 14, 2013

(54) Task Performance

(71) Applicants: Jari Nikara, Lempaala (FI); Eero Aho, Tampere (FI); Mika Pesonen, Tampere (FI); Zbigniew Stanek, Zbigniew (FI)

(72) Inventors: Jari Nikara, Lempaala (FI); Eero Aho, Tampere (FI); Mika Pesonen, Tampere (FI); Zbigniew Stanek, Zbigniew (FI)

(73) Assignee: NOKIA CORPORATION, ESPOO (FI)

(21) Appl. No.: 13/980,204

(22) PCT Filed: Jan. 18, 2011
(86) PCT No.: PCT/IB11/50219

§ 371 Date: Jul. 17, 2013

(51) Int. Cl. G06F 9/46

(52) U.S. Cl. CPC G06F 9/46
USPC 718/100

(57) ABSTRACT

A method including: identifying, for a current user input state, a plurality of available next user input states; defining a set of putative next user input states comprising including one or more of the available next user input states; defining a set of advancing tasks, in anticipation of the current user input state becoming, next, any one of the one or more putative next user input states of the set of putative next user input states; redefining the set of putative next user input states, including one or more of the available next user input states, in response to a user movement signal that depends upon user movement; and redefining the set of advancing tasks, in anticipation of the current user input state becoming, next, any one of the one or more putative next user input states of the set of putative next user input states

### TECHNOLOGICAL FIELD

Embodiments of the present invention relate to task performance. In particular, they relate to managing task performance to improve a user experience.

### BACKGROUND

When a user selects a user input item in a user interface a task associated with the input item is performed. In some instances, the task may take some time to complete. This delay may be frustrating for a user.

### BRIEF SUMMARY

When a user selects a user input item in a user interface a task associated with the input item is performed. A delay that may occur if the task is performed only after selection of the user input item can be reduced or eliminated by speculative performance of some or all the task. That is, by advancing some or all of the task in a pre-emptive or anticipatory manner, the performance load associated with the task is time shifted so that it is completed earlier, for example, shortly after the user input item has been selected.

Embodiments of the invention manage the speculative performance load.

According to various, but not necessarily all, embodiments of the invention there is provided a method comprising: identifying, for a current user input state, a plurality of available next user input states; defining a set of putative next user input states comprising one or more of the available next user input states; defining a set of advancing tasks comprising one or more advancing tasks, in anticipation of the current user input state becoming, next, any one of the one or more putative next user input states of the set of putative next user input states; redefining the set of putative next user input states, comprising one or more of the available next user input states, in response to a user movement signal that depends upon user movement; and redefining the set of advancing tasks comprising one or more advancing tasks, in anticipation of the current user input state becoming, next, any one of the one or more putative next user input states of the set of putative next user input states.

According to various, but not necessarily all, embodiments of the invention there is provided an apparatus comprising: means for identifying, for a current user input state, a plurality of available next user input states; means for defining a set of putative next user input states comprising one or more of the available next user input states; means for defining a set of advancing tasks comprising one or more advancing tasks, in anticipation of the current user input state becoming, next, any one of the one or more putative next user input states of the set of putative next user input states; means for redefining the set of putative next user input states, comprising one or more of the available next user input states, in response to a user movement signal that depends upon user movement; and means for redefining the set of advancing tasks comprising one or more advancing tasks, in anticipation of the current user input state becoming, next, any one of the one or more putative next user input states of the set of putative next user input states

According to various, but not necessarily all, embodiments of the invention there is provided an apparatus comprising: at least one processor; and at least one memory including computer program code the at least one memory and the computer program code configured to, with the at least one processor, cause the apparatus at least to perform identifying, for a current user input state, a plurality of available next user input states; defining a set of putative next user input states comprising one or more of the available next user input states; defining a set of advancing tasks comprising one or more advancing tasks, in anticipation of the current user input state becoming, next, any one of the one or more putative next user input states of the set of putative next user input states; redefining the set of putative next user input states, comprising one or more of the available next user input states, in response to a user movement signal that depends upon user movement; redefining the set of advancing tasks comprising one or more advancing tasks, in anticipation of the current user input state becoming, next, any one of the one or more putative next user input states of the set of putative next user input states.

According to various, but not necessarily all, embodiments of the invention there is provided a method comprising: identifying, for a current state, a plurality of available next states; defining a set of putative next states comprising one or more of the available next states; defining a set of advancing tasks comprising one or more advancing tasks, in anticipation of the current state becoming, next, any one of the one or more putative next states of the set of putative next states; redefining the set of putative next states, comprising one or more of the available next states, in response to a user movement; and redefining the set of advancing tasks comprising one or more advancing tasks, in anticipation of the current state becoming, next, any one of the one or more putative next states of the set of putative next states.

In handheld apparatus, there are limited performance resources, so management of the speculative performance load is particularly important.

A speculative performance load may, for example, be managed by selecting and re-selecting which tasks should be performed speculatively (selecting the advancing tasks).

A speculative performance load may, for example, be managed by allocating different resources to different tasks that are being performed speculatively (arbitration of advancing tasks).

### BRIEF DESCRIPTION

For a better understanding of various examples of embodiments of the present invention reference will now be made by way of example only to the accompanying drawings in which:

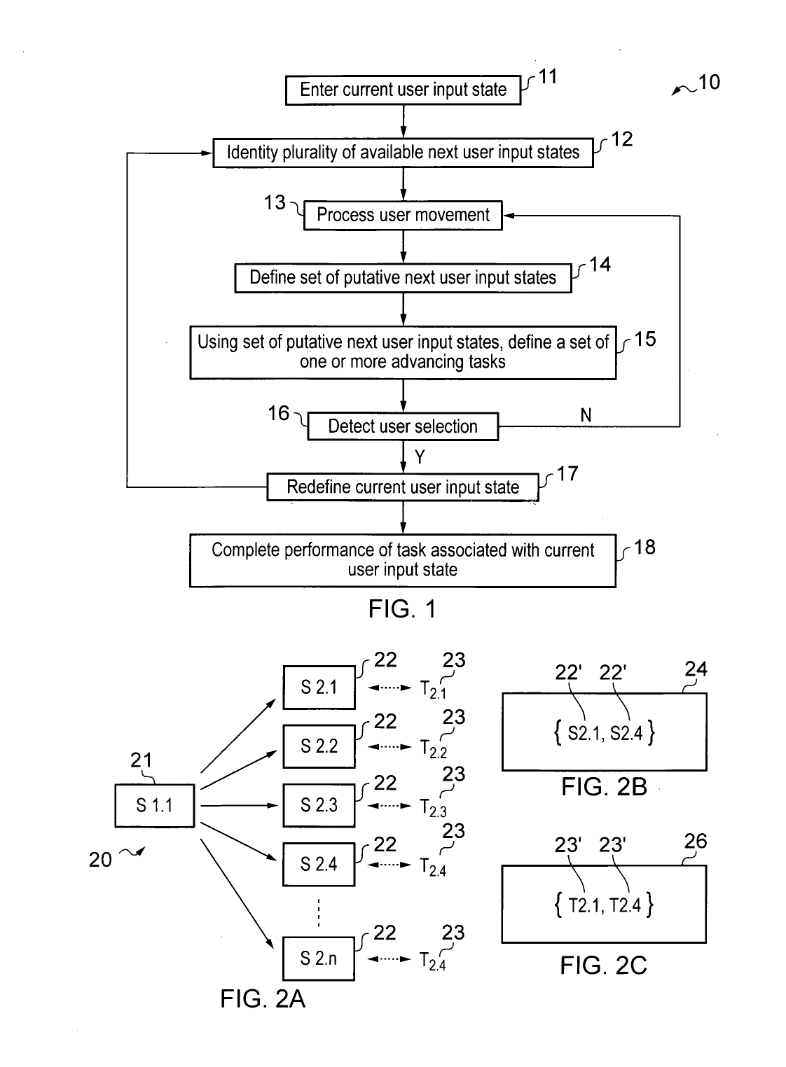

FIG. 1 illustrates an example of method for controlling the speculative performance of one or more tasks;

FIG. 2A illustrates an example of a portion of a state machine that defines user input states and transitions between a current user input state and available next user input states;

FIG. 2B illustrates an example of a set of putative next user input states comprising one or more available next user input states;

FIG. 2C illustrates an example of a set of advancing tasks comprising one or more advancing tasks, in anticipation of a current user input state becoming, next, any one of the one or more putative next user input states of the set of putative next user input states;

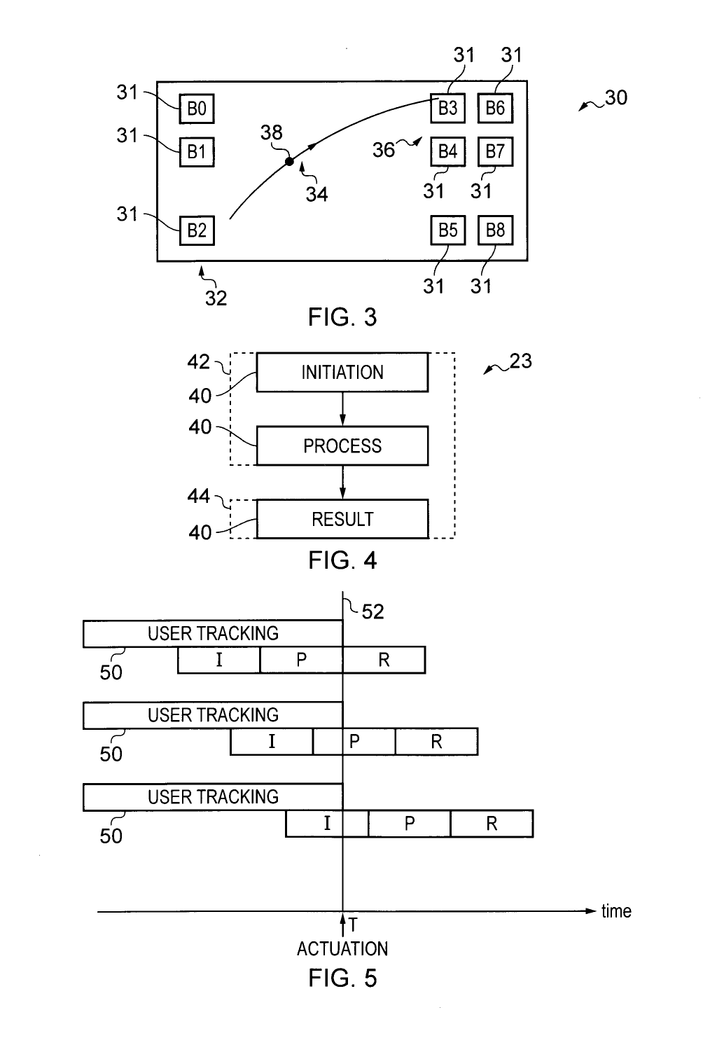

FIG. 3 illustrates an example of a user interface which is used by a user for user input;

FIG. 4 illustrates an example of a tasks associated with a user input item some of which may be performed speculatively and some of which may not;

FIG. 5 illustrates examples of how tasks may be performed speculatively;

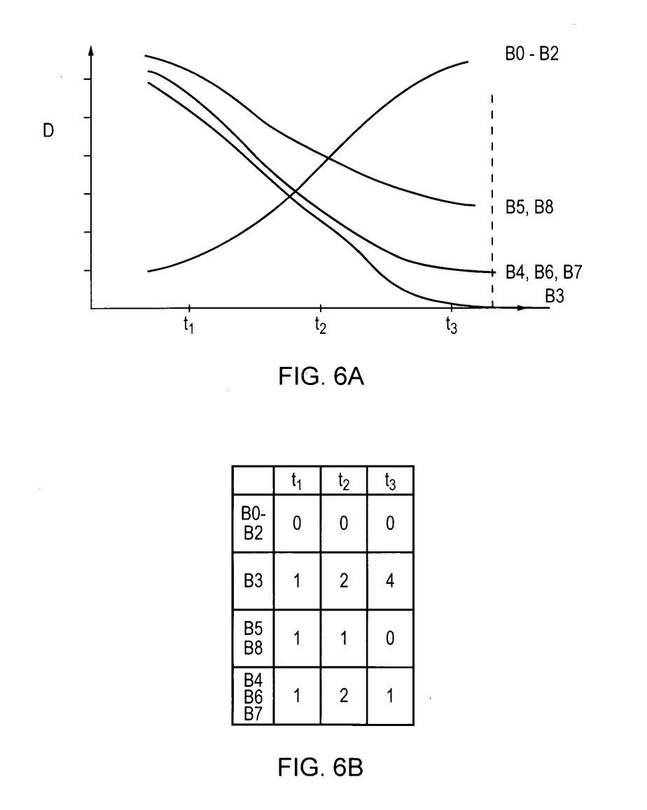

FIG. 6A illustrates an example of how an end-point of user movement may be estimated during the user movement;

FIG. 6B illustrates an example of how likelihoods of different end-points of user movement may vary during the user movement;

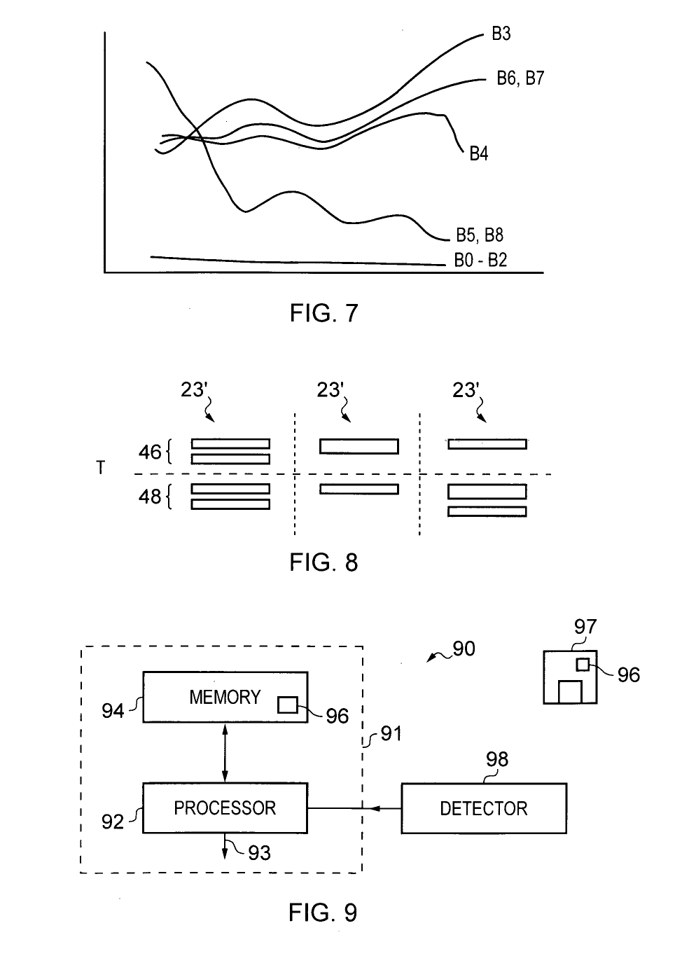

FIG. 7 illustrates another example of how an end-point of user movement may be estimated during the user movement;

FIG. 8 illustrates an example of different predictive tasks associated with different end-points;

FIG. 9 illustrates an example of an apparatus;

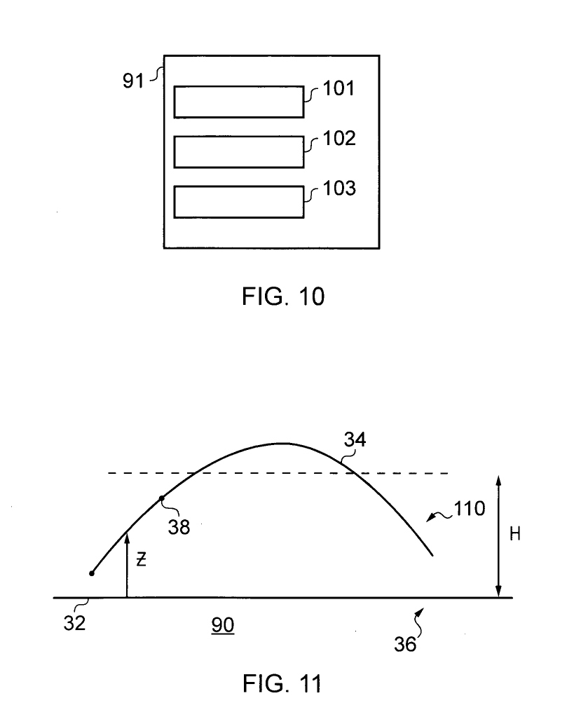

FIG. 10 illustrates an example of functional elements of an apparatus;

FIG. 11 illustrates an example of a three dimensional user input to reach an end-point.

### DEFINITIONS

An ‘advancing task’ is a task or sub-task that has been initiated and is in the process of execution but has not yet completed and is advancing towards completion. The advancement towards completion may be continuous or intermittent, because for example multiple tasks are advanced in parallel.

A user input state is a state in a state machine. Except for the initial state of the state machine, a user input state is a consequence of a completion of a user input (actuation) and is an end-point of a transition in the state machine. It may alternatively be referred to as a ‘user actuated state’ or an ‘end-point state’.

A user input stage is a transitory stage in a tracking of movement of a contemporaneous user input. The user input, when finally completed after a series of user input stages, may cause a transition in the state machine.

A distinction should be drawn between a user input state and a user input stage.

### DETAILED DESCRIPTION

FIG. 1 illustrates an example of a method 10 for controlling the speculative performance of one or more tasks.

FIG. 2A illustrates an example of a portion of a state machine 20 that defines user input states Sn.n and transitions between a current user input state 21 and available next user input states 22.

FIG. 2B illustrates an example of a set 24 of putative next user input states 22′ comprising one or more available next user input states 22. There is a correspondence or association between available next user input states 22 and tasks 23.

FIG. 2C illustrates an example of a set 26 of advancing tasks comprising one or more advancing tasks 23′, in anticipation of a current user input state 21 becoming, next, any one of the one or more putative next user input states 22′ of the set 24 of putative next user input states 22′. There is a correspondence or association between members of the set 24 of putative next user input states 22′ and members of the set 26 of advancing tasks.

FIG. 3 illustrates an example of a user interface 30 which is used by a user for user input.

Referring to FIG. 1 in particular, but also referencing FIGS. 2 and 3, FIG. 1 illustrates an example of a method 10 for controlling the speculative performance of one or more tasks 23′.

The method 10 comprises a number of blocks 11-18.

At block 11, the method 10 enters a current user input state 21 (see, for example, FIG. 2A).

Next at block 12, the method 10 identifies, for a current user input state 21, a plurality of available next user input states 22 (see, for example, FIG. 2A).

Next at block 13, the method 10 processes a detected user movement 34 (see, for example, FIG. 3).

Next at block 14, the method 10 defines a set 24 of putative next user input states 22′ comprising one or more of the available next user input states 22 (see, for example, FIG. 2B). The set of putative next user input states may be defined based on respective likelihoods that available next user input states 22 will become, next, the current user input state.

Next at block 15, the method 10 defines a set of advancing tasks 26 comprising one or more advancing tasks 23′, in anticipation of the current user input state 21 becoming, next, any one of the one or more putative next user input states 22′ of the set 24 of putative next user input states 22′ (See, for example, FIGS. 2A and 2C).

An advancing task is a task or sub-task that has been initiated and is in the process of execution but has not yet completed and is advancing towards completion. The advancement towards completion may be continuous or intermittent, because for example multiple tasks are advanced in parallel.

In some examples, each user input state 22 is associated with at least one task 23 (see, for example, FIG. 2A). In some but not necessarily all embodiments, the inclusion of a user input state 22 in the set 24 of putative next user input states 22′ results in the automatic inclusion of its associated task 23 in the set 26 of advancing tasks 23′ causing the initiation of the task 23. The exclusion of a user input state 22 from the set 24 of putative next user input states 22′ results in the automatic exclusion of its associated task 23 from the set 26 of advancing tasks 23′ preventing or stopping the advancement of the task 23.

Next at block 16, it is determined whether a user selection event has occurred A user selection event changes the current user input state 21 from its current user input state to one of the available next user input states 22. That is, the user selection event causes a transition within the user input state machine 20 (see, for example, FIG. 2A). If a user selection event has occurred, the method 10 moves to block 17. If a user selection event has not occurred the method 10 moves back to block 13 for another iteration.

If the method 10 moves back to block 13, detected user movement 34 is processed (see, for example, FIG. 3). Then at block 14, the method 10 redefines the set 24 of putative next user input states 22′, comprising one or more of the available next user input states 22, in response to the user movement 34. Then at block 15, the method 10 redefines the set 26 of advancing tasks 23′ comprising one or more advancing tasks 23′, in anticipation of the current user input state 21 becoming, next, any one of the one or more of the putative next user input states 22′ of the set 24 of putative next user input states 22′.

In this way, while the user is moving towards making an actuation, which causes a user selection event to occur, the method 10 is repeatedly redefining the set 24 of putative next user input states 22 which in turn redefines the set 26 of advancing tasks 23′.

At block 17, the method 10 redefines the current user input state 21. The method then branches returning to block 12 and also moving on to block 18. The return to block 12 restarts the method 10 for the new current user input state.

At block 18, the performance of the task 23 associated with the new current user input state is accelerated (from a perspective of a user) because the predictive processing of some or all of the task 23 results in a consequence of the new current user input state being brought forward in time. The predictive processing is controlled by defining and redefining the advancing tasks 23′.

An advancing task 23′ is a task that has been initiated and is in the process of execution but has not yet completed and is advancing towards completion. The advancement towards completion may be continuous or intermittent, because for example multiple tasks are advanced in parallel.

In the example of FIG. 3, a user input item 31 has been selected to define the current user input state 21. The selected user input item B2 represents a start-point for a movement 34 of a selector 38. The selector 38 may, for example, be a cursor on a screen, or a user's finger or a pointer device. The user movement 34 is away from the selected user input item B2 towards another user input item B3 which represents an end-point 36 for the movement 34 that selects the user input item B3.

The user movement 34 may, for example be logically divided into a number of user input stages. A user input stage is a transitory stage in a tracking of movement of a contemporaneous user input 34. The user input, when finally completed after a series of user input stages, may cause a transition in the state machine.

Referring to this example, at block 14 of the method 10, the set 24 of putative next user input states 22′ is defined or redefined in dependence upon the user movement 34 relative to the selected user input item B2.

A user input stage in the user movement 34 determined at block 13 may be assumed to represent a transitory stage in a user movement that will make a user selection that defines the next current user input state. This assumption allows the redefinition of the set 24 of putative next user input states 22′ in dependence upon a trajectory of the user movement 34 and/or the kinematics of the user movement 34. By analyzing the trajectory and/or kinematics of the user movement 34, the likelihood that any particular selectable user input item 31 will be the end-point 36 of the user movement 34 is determined. Predictive processing may then be focused on the tasks 23 associated with those user input states 22 that are most likely to become the next current user input state or on the task or tasks 23 associated with the user input state 23 that is most likely to become the next current user input state.

The kinematics used to determine the likelihood that any particular selectable user input item 31 will be the end-point 36 of the user movement 34 may include, for example, displacement, speed, acceleration, or change values of these parameters.

FIG. 6A illustrates an example of how an end-point 36 of user movement 34 may be estimated at different user input stages during the user movement 34. The figure plots separately, for each of the selectable user input items 31 (B0-B8) associated with respective available next user input states 22, the distance D between a selector 38 controlled by a user and the respective selectable user input items 31.

As the selector 38 moves away from the selected user input item 31 towards the selectable user input item B3, the distance between the selector 38 and the items B0, B1, B2 increases, the distance between the selector 38 and the remaining items B3-B8 initially decreases between times t1 and t2. Then between time t2 and t3, the distance between the selector 38 and the items B3-B8 initially decreases but the rate of decrease diminishes for B4-B8 but not B3 indicating that at time t3 B3 is the most likely endpoint 36 of the selector 38.

The user movement 34 determined at block 13 may be assumed to represent user movement that will make a user selection that defines the next current user input state. By analyzing the distance D between the selector 38 controlled by a user and selectable user input items 31 associated with respective available next user input states 22, the likelihood that any particular selectable user input item 31 will be the end-point 36 of the user movement 34 can be determined.

FIG. 6B illustrates an example of how likelihoods of different end-points of user movement may vary during the user movement depicted in FIG. 6A.

At time t1, the items B3-B8 are indicated as possible end-points (value 1) and the items B0-B2 are indicated as unlikely end-points (value 0). It may be therefore that at t1, the set 24 of putative next user input states 22′ comprises the user input states 22 associated with the items B3-B8 but not the user input states 22 associated with the items B0-B2. The set of advancing tasks 26 then comprises advancing tasks 23′ relating to the possible selection of any of items B3-B8.

At time t2, the items B5, B8 are indicated as possible end-points (value 1) and the items B3 and B4, B6, B7 are indicated as likely end-points (value 2).

It may be therefore that at t2, the set 24 of putative next user input states 22′ comprises the user input states 22 associated with the items B3-B4 and B6-B7 but not the user input states 22 associated with the items B0-B2, B5 and B8. The set of advancing tasks 26 would then comprise advancing tasks 23′ relating to the possible selection of any of items B3-B4 and B6-B7.

Alternatively, it may be therefore that at t2, the set 24 of putative next user input states 22′ comprises the user input states 22 associated with the items B3-B8 but not the user input states 22 associated with the items B0-B2. The set of advancing tasks 26 then comprises advancing tasks 23′ relating to the possible selection of any of items B3-B8. However, in this example it may be that there is ordering applied to the set 24 (and consequently to the set 26) or applied to the set 26 and that greater resources are directed towards the advancement of the tasks relating to items B3, B4, B6, B7 (value 2) than items B5, B8 (value 1) so that they advance more quickly.

At time t3, the items B5, B8 are indicated as unlikely end-points (value 0), the items B4, B6, B7 are indicated as possible end-points (value 1) and the item B3 is indicated as a very likely end-point (value 4).

It may be therefore that at t3, the set 24 of putative next user input states 22′ comprises only the user input state 22 associated with the item B3. The set 26 of advancing tasks 26 only comprises the advancing task 23′ relating to the possible selection of the item B3.

Alternatively, it may be therefore that at t3, the set 24 of putative next user input states 22′ comprises the user input states 22 associated with the items B3, B4, B6, B7. The set of advancing tasks 26 comprises advancing tasks 23′ relating to the possible selection of any of items B3, B4, B6, B7. However, in this example it may be that there is ordering applied to the set 24 (and consequently to the set 26) or applied to the set 26 and that greater resources are directed towards the advancement of the task relating to item B3 (value 4) than items B4, B6, B7 (value 1).

In these ways, predictive processing is focused on the tasks 23 associated with those user input states that are most likely to become the next current user input state or on the task or tasks 23 associated with the user input state that is most likely to become the next current user input state.

A large initial uncertainty is reflected in the relatively large size of the set 24 of putative next user input states 22 at time t1. As method 10 iterates, increasing certainty is reflected in the reducing size of the set 24 of putative next user input states 22 at times t2, t3.

At block 14, the set of putative next user input states may be redefined by keeping an available next user input state within the set 24 of putative next user input states 22′ while a relationship between a position of a selector controlled by a user and a selectable user input item, associated with the first available next user input state, is satisfied and by removing a second available next user input state from the set 24 of putative next user input states 22′ when a relationship between the position of the selector controlled by the user and a selectable user input item, associated with the second available next user input state, is no longer satisfied. In the example illustrated in FIGS. 6A and 6B, the condition may be satisfied, for example, when a distance between the selector 38 controlled by a user and the respective selectable user input item 31 decreases by a threshold amount within a defined time.

FIG. 7 illustrates another example of how an end-point 36 of user movement 34 may be estimated during the user movement; The figure plots separately, for each of the selectable user input items 31 (B0-B8) associated with respective available next user input states 22, a function F that depends upon both a distance between a selector 38 controlled by the user and the respective selectable user input items 31 and an angle between the selector 38 controlled by a user and the respective selectable user input items 31.

As the selector 38 moves away from the selected user input item 31 towards the selectable user input item B3: the function for the items B0, B1, B2 remains low, the function for the items B5, B8 quickly reduces, and the function for the items B3, B4, B6, B7 remain similar until B3 is approached relatively closely.

By analyzing the function F, the likelihood that any particular selectable user input item 31 will be the end-point 36 of the user movement 34 can be determined.

Block 14, that defines or redefines the set of putative next user input states may, in all or some iterations, include preferentially in the set of putative next user input states user input states that have been selected previously by the user. History data may be stored recording which trajectories and/or which kinematics of the user movement 34 most probably have a particular selectable user input item 31 as an end-point 36 of the user movement 34. This history data may be used when analyzing the trajectory and/or kinematics of the user movement 34 to help determine the likelihood that any particular selectable user input item 31 will be the end-point 36 of the user movement 34.

In some implementations, a self-learning algorithm may be used to continuously adapt and improve the decision making process based upon information concerning the accuracy of the decision making process.

In some implementations, a stored user profile may be maintained that records, for example, the frequency with which different transitions within the user input state machine occur. The profile may, for example, be a histogram.

At block 15, in addition to defining the set of one or more advancing tasks, the method 10 may additionally determine whether and how the advancing tasks are prioritized, if at all. For example it may control the speed of advancement of each advancing task. Prioritizing of advancing tasks may, for example, be based upon any one or more of: comparative likelihoods that respective user input states will become, next, the current user input state; comparative loads of the advancing tasks; comparative times for completing the advancing tasks; a history of user input states that have been selected previously by the user; and a user profile

In the example of FIG. 6A, 6B, the selection and/or reordering of the putative user input states 22′ in the set 24 and the selection and/or reordering of the tasks 23′ in the set 26 are based upon distance between the selector 38 controlled by a user and the respective selectable user input items 31.

However, the selection and/or re-ordering may, for example, be based upon any one or more of: user movement relative to selectable user input items; a trajectory of user movement; kinematics of user movement; a change in distance between the selector controlled by a user and selectable user input items associated with respective available next user input states; an angle between a selector controlled by a user and selectable user input items associated with respective available next user input states; a change in displacement between a selector controlled by a user and selectable user input items associated with respective available next user input states; a distance of the user movement from a reference; satisfaction of a relationship between a position of a selector controlled by a user and selectable user input items, associated with the available next user input states; likelihoods that available next user input states will become, next, the current user input state; a history of user input states that have been selected previously by the user; and a user profile.

FIG. 4 illustrates an example of a task 23 associated with a user input state 22/user input item 31. This task 23 is only an example of one type of task and other tasks are possible. The task 23 comprises a plurality of sub-tasks 40 including an initiation sub-task, a processing sub-task and a result sub-task.

The initiation sub-task may be a task that obtains data for use in the processing sub-task. The result sub-task may be a task that uses a result of the processing sub-task to produce an output or consequence.

Some or all of the initiation sub-task and the processing sub-task are, in this example, pre-selection tasks 42 that may be performed speculatively before user selection of a user input item 31. The result sub-task is, in this example, a post-selection task 44 and cannot be performed speculatively but only after user selection of a user input item 31.

FIG. 5 illustrates three examples of how tasks may be performed speculatively;

In each example, user selection of a user input item occurs 52 at time T. In each example, there is tracking 50 of user movement. Referring to FIG. 1, the user tracking corresponds with block 13. As a consequence of blocks 14, 15 an advancing task 23′ is defined.

In the first example, the initiation sub-task (I) and the processing sub-task (P) of the advancing task 23′ are completed before time T as advancing tasks. The result sub-task (R) is initiated and completed after time T.

In the second example, the initiation sub-task (I) but not the processing sub-task (P) of the advancing task 23′ is completed before time T as an advancing task. The processing sub-task (P) is completed after time T. The result sub-task (R) is initiated and completed after time T.

In the third example, neither the initiation sub-task (I) nor the processing sub-task (P) of the advancing task 23′ is completed before time T. The initiation sub-task (I) is completed after time T. The processing sub-task (P) and the result sub-task (R) are initiated and completed after time T.

FIG. 8 illustrates an example of different predictive tasks 23′ associated with different end-points 36.

In this example, a user input state associated with a particular end-point can define a plurality of sub-tasks. These sub-tasks execute as advancing tasks when the associated user input state is a member of the set 24 of putative next user input states 22′ and a respective criterion is satisfied.

For example, the sub-tasks associated with a user input state may be ordered and the sub-tasks may be executed, in order, as and when a likelihood of the current user input state becoming, next, that user input state passes respective threshold trigger values.

In FIG. 8, three groups of sub-tasks 46 associated with three respective different user input states are executed. The sub-tasks within each group are executed in order. When a likelihood that one of the three user input states will become next the current user input state passes a threshold trigger value T, a next group of sub-tasks 48 associated with that user input state is executed. Some or all of next group of sub-tasks 48 may be child tasks to the sub-tasks 46, that is they may require the completion of some or all of the sub-tasks 46. Some or all of the next group of sub-tasks 48 may be independent of the sub-tasks 46, that is they may not require the completion of any of the sub-tasks 46.

FIG. 9 illustrates an example of an apparatus 90 comprising a controller 91 and a movement detector 98. The apparatus 90 may, for example, be a hand portable apparatus sized and configured to fit into a jacket pocket or may be a personal electronic device.

The movement detector 98 is configured to detect user movement and provide a user movement signal to the controller 91. The movement detector 98 may, for example, be a capacitive sensor, a touch screen device, an optical proximity detector, a gesture detector or similar.

The controller 91 is configured to perform the control of speculative tasks, for example, as described above. For example, the controller 91 may be configured to perform the method 10 illustrated in FIG. 1.

Referring to FIG. 10, the controller 91 comprises:

means 101 for identifying, for a current user input state, a plurality of available next user input states;

means 102 for defining a set of putative next user input states comprising one or more of the available next user input states;

means 103 for defining a set of advancing tasks comprising one or more advancing tasks, in anticipation of the current user input state becoming, next, any one of the one or more putative next user input states of the set of putative next user input states;

means 102 for redefining the set of putative next user input states, comprising one or more of the available next user input states, in response to a user movement signal that depends upon user movement; and

means 103 for redefining the set of advancing tasks comprising one or more advancing tasks, in anticipation of the current user input state becoming, next, any one of the one or more putative next user input states of the set of putative next user input states.

The controller 91 may be implemented using instructions that enable hardware functionality, for example, by using executable computer program instructions 96 in a general-purpose or special-purpose processor 92 that may be stored on a computer readable storage medium (disk, memory etc) to be executed by such a processor.

In FIG. 9, a processor 92 is configured to read from and write to the memory 94. The processor 92 may also comprise an output interface via which data and/or commands 93 are output by the processor 92 and an input interface via which data and/or commands are input to the processor 92.

The memory 94 stores a computer program 96 comprising computer program instructions that control the operation of the apparatus 90 when loaded into the processor 92. The computer program instructions 96 provide the logic and routines that enables the apparatus to perform the methods illustrated in FIG. 1, for example. The processor 92 by reading the memory 94 is able to load and execute the computer program 96.

The apparatus 90 therefore comprises: at least one processor 92; and

at least one memory 94 including computer program code 96, the at least one memory 94 and the computer program code 96 configured to, with the at least one processor 92, cause the apparatus 90 at least to perform:

identifying, for a current user input state, a plurality of available next user input states;

defining a set of putative next user input states comprising one or more of the available next user input states;

defining a set of advancing tasks comprising one or more advancing tasks, in anticipation of the current user input state becoming, next, any one of the one or more putative next user input states of the set of putative next user input states;

redefining the set of putative next user input states, comprising one or more of the available next user input states, in response to a user movement signal that depends upon user movement; and

redefining the set of advancing tasks comprising one or more advancing tasks, in anticipation of the current user input state becoming, next, any one of the one or more putative next user input states of the set of putative next user input states.

The computer program may arrive at the apparatus 90 via any suitable delivery mechanism 97. The delivery mechanism 97 may be, for example, a computer-readable storage medium, a computer program product, a memory device, a record medium such as a compact disc read-only memory (CD-ROM) or digital versatile disc (DVD), an article of manufacture that tangibly embodies the computer program 96. The delivery mechanism may be a signal configured to reliably transfer the computer program 96. The apparatus 10 may propagate or transmit the computer program 96 as a computer data signal.

Although the memory 94 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

FIG. 11 illustrates, in cross-sectional view, an example of a three dimensional user movement 34 to reach an end-point 36. The user movement 34 has a trajectory that takes it a distance z away orthogonally from a surface 112 of the apparatus 90.

The apparatus 90 has a proximity detection zone 110. In this example, the zone terminates at a height H from the surface 110 of the apparatus 90. While the selector 38 is within the proximity detection zone 110 movement of the selector 38 can be tracked. When the selector 38 exits the proximity detection zone 110 (z>H) movement of the selector 38 cannot be tracked.

In the event that tracking of the selector 38 is lost, then the likelihoods that the available user input states will become, next, the current user input state may be fixed until tracking is regained. Thus the set 24 of putative user input states 22′ and the set 26 of advancing tasks 23′ may be fixed, until tracking of the selector 38 is regained. The advancing task(s) continue to advance while tracking is lost.

The locations where tracking is lost and regained may provide valuable information for estimating likelihoods that the available user input states will become, next, the current user input state.

The displacement z may be used to assess the trajectory of the selector 38 and the likelihoods that the available user input states will become, next, the current user input state. The set of putative next user input states may therefore be redefined in dependence upon a distance z of the user movement from a reference surface 110 of the apparatus 90. The distance z may, for example, act as an additional constraint that operates to reduce the set of putative next user input states compared to the two-dimensional example described previously.

Some embodiments may find particular application for haptic input devices. For example, the task associated with a potential end-point 36 of the user movement 34 may be uncompressing the area including that end-point to a memory of microcontrollers.

Some embodiments may find particular application for image management. For example, the task associated with a potential end-point 36 of the user movement 34 may be transferring an image from a memory card to operational memory, so that the image is available immediately when a user selects an icon at that end-point 36.

Some embodiments may find particular application for image processing. For example, the task associated with a potential end-point 36 of the user movement 34 may be compilation of a kernel for image processing, so that an image can be processed (e.g. blur, filter, scale) immediately when a user selects an icon at that end-point 36.

Some embodiments may find particular application for web-browsing. For example, the task associated with a potential end-point 36 of the user movement 34 may be a domain name server prefetch or an image prefetch, so that a link can be navigated immediately when a user selects the link at that end-point 36. A series of tasks may be predicatively carried out. For example, connecting to a server, downloading hyper text mark-up language of a web-page, download and decode images. Each task may be carried out in order only when a likelihood that the end-point 36 will be on the link exceeds a respective threshold. This results in significant processing occurring only when ambiguity concerning the end-point is reducing.

In some embodiments, the controller 91 may be located in a server remotely located from the movement detector 98. In this example, the user movement signals would be transmitted from the detector 98 to the remote server.

Referring to FIG. 3, the user interface 30 may be fixed during movement 34 of the selector 38. For example, the selectable user input items may remain fixed.

The controller 91 may be a module. As used here ‘module’ refers to a unit or apparatus that excludes certain parts/components that would be added by an end manufacturer or a user.

The blocks illustrated in FIG. 1 may represent steps in a method and/or sections of code in the computer program 96. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
identifying, for a current user input state, a plurality of available next user input states;
defining a set of putative next user input states comprising one or more of the available next user input states;
defining a set of advancing tasks comprising one or more advancing tasks, in anticipation of the current user input state becoming, next, any one of the one or more putative next user input states of the set of putative next user input states; redefining the set of putative next user input states, comprising one or more of the available next user input states, in response to a user movement signal that depends upon user movement; and
redefining the set of advancing tasks comprising one or more advancing tasks, in anticipation of the current user input state becoming, next, any one of the one or more putative next user input states of the set of putative next user input states.

2. (canceled)

3. (canceled)

4. A method as claimed in claim 1, comprising redefining the set of putative next user input states in dependence upon user movement relative to selectable user input items.

5. A method as claimed in claim 1, comprising redefining the set of putative next user input states in dependence upon a trajectory of user movement.

6. A method as claimed in claim 1, comprising redefining the set of putative next user input states in dependence upon kinematics of user movement.

7. (canceled)

8. (canceled)

9. (canceled)

10. A method as claimed in claim 1, comprising redefining the set of putative next user input states by keeping an available next user input state within the set of putative next user input states when a distance between a selector controlled by a user and a selectable user input item decreases and by removing an available next user input state from the set of putative next user input states when a distance between a selector controlled by a user and a selectable user input item increases beyond a threshold.

11. (canceled)

12. A method as claimed in claim 1, comprising redefining the set of putative next user input states by keeping a first available next user input state within the set of putative next user input states while a relationship between a position of a selector controlled by a user and a selectable user input item, associated with the first available next user input state, is satisfied and by removing a second available next user input state from the set of putative next user input states when a relationship between the position of the selector controlled by the user and a selectable user input item, associated with the second available next user input state, is no longer satisfied.

13. (canceled)

14. A method as claimed in claim 1, comprising redefining the set of putative next user input states to include preferentially user input states that have been selected previously by the user.

15. A method as claimed in claim 1, comprising redefining the set of putative next user input states in dependence upon a history of user input states that have been selected previously by the user.

16. A method as claimed in claim 1, comprising redefining the set of putative next user input states in dependence upon a user profile.

17. (canceled)

18. (canceled)

19. A method as claimed in claim 1, wherein a task completed, when the current user input state becomes one of the putative next user input states, comprises one or more of: an initiation task, a processing task and a result task and wherein
an advancing task performed in anticipation of the current user input state becoming, next, one of the putative next user input states of the set of putative next user input states comprises one or more of the initiation task and the processing task but does not include the result task,

20. (canceled)

21. A method as claimed in claim 1, wherein a first user input state defines a plurality of associated tasks each of which executes as an advancing task when both the first user input state is a member of the set of putative next user input states and a respective task criterion is satisfied wherein task criterion are based upon a likelihood of the current user input state becoming, next, the first user input state.

22. (canceled)

23. (canceled)

24. (canceled)

25. A method as claimed in claim 1, wherein an advancing task is a task that is in the process of execution and execution of the task is advancing.

26. A method as claimed in claim 1, comprising, when the set of advancing tasks comprises multiple advancing tasks, determining the speed of advancement, in parallel, of each advancing task.

27. A method as claimed in claim 1, wherein, when the set of advancing tasks comprises multiple advancing tasks, prioritizing at least one advancing task over at least one other advancing task.

28. A method as claimed in claim 27, wherein prioritization is dependent upon any one or more of:
user movement relative to selectable user input items;
a trajectory of user movement;
kinematics of user movement;
a change in distance between a selector controlled by a user and selectable user input items associated with respective available next user input states;
an angle between a selector controlled by a user and selectable user input items associated with respective available next user input states;
a change in displacement between a selector controlled by a user and selectable user input items associated with respective available next user input states;
a distance of the user movement from a reference;
satisfaction of a relationship between a position of a selector controlled by a user and selectable user input items, associated with the available next user input states;
likelihoods that available next user input states will become, next, the current user input state;
a history of user input states that have been selected previously by the user;
a stored user profile; and
a user profile.

29. A method as claimed in claim 1, wherein a first advancing task, but not a second advancing task, is utilised when the current user input state becomes a first input state and wherein the second advancing task, but not the first advancing task, is utilised when the current user input state becomes a second user input state.

30. (canceled)

31. (canceled)

32. (canceled)

33. (canceled)

34. An apparatus comprising:
at least one processor; and
at least one memory including computer program code the at least one memory and the computer program code configured to, with the at least one processor, cause the apparatus at least to perform identifying, for a current user input state, a plurality of available next user input states;
defining a set of putative next user input states comprising one or more of the available next user input states;
defining a set of advancing tasks comprising one or more advancing tasks, in anticipation of the current user input state becoming, next, any one of the one or more putative next user input states of the set of putative next user input states; redefining the set of putative next user input states, comprising one or more of the available next user input states, in response to a user movement signal that depends upon user movement;
redefining the set of advancing tasks comprising one or more advancing tasks, in anticipation of the current user input state becoming, next, any one of the one or more putative next user input states of the set of putative next user input states.

35. An apparatus as claimed in claim 34, comprising a proximity sensor.

36. (canceled)

37. An apparatus as claimed in claim 35, sized and configured as a hand portable apparatus.

38. A computer program that, when run on a computer, performs: the methods of claim 1.

39. (canceled)
